(19) United States
(12) Patent Application Publication
(10) Pub. No.: US 2004/0162366 A1
(43) Pub. Date: Aug. 19, 2004

(54) Process for the preparation of binder dispersions capable of being cathodically deposited using crosslinking agents based on polyisocyanates blocked by amino groups

(76) Inventors: Michael Geist, Ludwigshafen (DE); Klaus Cibura, Southfield, MI (US); Walter Jouck, Munster (DE); Gunther Ott, Munster (DE); Jurgen Sadlowski, Munster (DE); Manfred Dangschat, Drensteinfurt (DE); Manfred Reimann, Munster (DE)

Correspondence Address: Richard L. Mayer, Esq., Kenyon & Kenyon, One Broadway, New York, NY, 10004, US

(21) Appl. No.: 10/369,850

(22) Filed: Feb. 19, 2003

(51) Int. Cl. C08L 63/00

(52) U.S. Cl. 523/400

(57) ABSTRACT

The invention relates to a process for the preparation of aqueous dispersions to be further processed to electrocoating paints with baking temperatures below 160° C. and baking times of ≦30 minutes, which dispersions contain modified epoxide-amine adducts as binders and polyisocyanates blocked by amino groups as crosslinking agents.

In this process, polyepoxides and compounds which contain one or more, preferably 2, hydroxyl groups per molecule are converted at higher temperatures and in the presence of catalysts to epoxide-containing intermediates.

A solvent or a mixture of solvents is then added with external cooling and the solution is then caused to boil under reflux, if necessary by application of a vacuum, until the temperature of the solution drops to 95° C. to 20° C.

Amines are then added onto the epoxide groups which are still present in a free state in the epoxide resin and either a dispersion is prepared after the addition of the crosslinking agent by adding a water-acid mixture or the products are first dispersed and the crosslinking agent is added subsequently.

The invention relates to a process for the preparation of aqueous dispersions to be further processed to electro-coating paints with baking temperatures below 160° C. and baking times of ≦30 minutes, which dispersions contain modified epoxide-amine adducts as binders and polyisocyanates blocked by amino groups as crosslinking agents.

Cathodic electrocoating is a painting process frequently used particularly for priming, in which water-thinnable synthetic resins carrying cationic groups are deposited on electrically conducting objects with the aid of direct current. The binders which are suitable for the cathodic deposition, contain predominantly amino groups which are neutralized with acids in order to render the binders soluble in water.

A particularly preferred group of binders is represented by the group of binders which are based on modified epoxy resins. Binders of this type are disclosed, for example, in the following patent documents: U.S. Pat. No. 4,031,050, U.S. Pat. No. 3,799,854, U.S. Pat. No. 3,984,299, U.S. Pat. No. 4,252,703, U.S. Pat. No. 4,332,711 and U.S. Pat. No. Des. 3,108,073.

They are crosslinkable by virtue of admixed polyisocyanates blocked by amino groups. These crosslinking agents thus contain at room temperature urea groups (=blocked isocyanate groups). The blocking components are then split off at elevated temperatures and the isocyanate groups are regenerated. Subsequently, these isocyanate groups may affect the crosslinking of the binders via the hydroxyl groups and/or the primary and/or secondary amino groups contained therein. Such non-selfcrosslinking binder systems represent the present state of the art. Their structure and preparation are described, for example, in U.S. Pat. No. Des. 3,108,073, particularly in Examples 1 to 5, or in EP 74,634 A2, Example A.

The crosslinking agents used therein react, because of the structure of their blocking components, only at temperatures above 160° C. The method described in the examples can therefore be followed without any difficulties.

However, in recent years the demand has steadily grown for crosslinking agents which become active at considerably lower baking temperatures. This is due in the automotive industry, for example, to the joint use of plastic components in the construction of automobile bodies.

Attempts have therefore been made to prepare suitable blocked polyisocyanates as crosslinking agents for reduced baking temperatures. A blocking component particularly suitable for this purpose is the secondary amino group. Such crosslinking agents based on aliphatic and aromatic polyisocyanates having secondary dialkylamines as blocking components are described, for example, in U.S. Pat. No. Des. 3,311,516. However, if these crosslinking agents are used instead of the crosslinking agents described above, the resultant paint surface lacks reproducible properties and exhibits breakdown phenomena and poor flow-out.

It is thus the object of the invention to make available a process which would make it possible, even when using crosslinking agents with low baking temperatures and modified epoxide-amine adducts as binders, to obtain aqueous dispersions which give rise, after being further processed to electrocoating paints, to reproducible surfaces formed by cathodic electrocoating with very good mechanical properties.

This object is achieved according to the invention by a process for the preparation of aqueous binder/crosslinking agent dispersions, wherein

(1) (A) polyepoxides and

(B) compounds which contain one or more, preferably 2, hydroxyl groups attached to aromatic and/or (cyclo)aliphatic molecular fragments per molecule,

are reacted in the presence of catalysts at elevated temperatures, preferably at from 100 to 180° C., to furnish

(C) epoxide-containing intermediates;

(2) (D) a solvent or a mixture of solvents is added with cooling by a secondary circuit (for example cooling via cooling coils filled with heat transfer oil or water) and the resultant resin solution is caused to boil under reflux, if necessary by application of a vacuum, until the temperature of the solution drops to 95° C. to 20° C.;

(3) (E) amines are added onto the epoxide groups which are still present in a free state in the epoxide resin and either

(4a) these reaction products are dispersed in a water-acid mixture and the crosslinking agent (F) is admixed, or

(4b) the crosslinking agent (F) is mixed with these products and this mixture is dispersed in a water-acid mixture.

In the first stage of the process according to the invention epoxide-containing intermediates are first prepared from the components (A) and (B) in the presence of catalysts.

Any compound whose molecule contains on average more than 1 epoxide group, may be used as the component (A). Preferred compounds are those which contain 2 epoxide groups in the molecule and have a relatively low molecular weight of not more than 750, preferably 350 to 500.

Particularly preferred epoxide compounds are polyglycidyl ethers of polyphenols prepared from polyphenols and epihalohydrins. Bisphenol A may preferably be used as the polyphenol.

Polyglycidyl esters of polycarboxylic acids may also be used. Glycidyl adipate and glycidyl phthalate are typical examples.

Hydantoin epoxides, epoxidized polybutadiene and polyepoxide compounds which are obtained by epoxidation of an olefinically unsaturated alicyclic compound, are furthermore suitable.

Compounds which contain one or more, preferably 2, hydroxyl groups attached to aromatic and/or (cyclo)aliphatic molecular fragments per molecule, are used as the component (B).

Compounds which are suitable as the component (B), include both low-molecular and high-molecular compounds.

Suitable low-molecular components (B) are phenolic, aliphatic and/or polyfunctional alcohols of a molecular weight below 350.

Examples of these are: diols, such as ethylene glycol, dipropylene glycol, triglycol, 1,2-propanediol, 1,3-propanediol, 2,2-dimethyl-1,3-propanediol, 2-methyl-2-propyl-1,3-propanediol, 1,2-butanediol, 1,4-butanediol, 2-ethyl-1,4-butanediol, 2-butene-1,4-diol, 1,2-pentanediol, 1,5-pentanediol, 3-methyl-1,5-pentanediol, 1,6-hexanediol, 2-hydroxyethyl hydroxyacetate, 2,2-dimethyl-3-hydroxypropyl 2,2-dimethyl-hydroxypropionate, 4,4′-methylenebiscyclohexanol and 4,4′-isopropylidenebiscyclohexanol. 2,2-Dimethyl-1,3-propanediol and 3-methyl-1,5-pentanediol are some of the preferred diols.

Examples of higher molecular components (B) are polyester polyols, polyether polyols or polycaprolactone polyols of various functionality and molecular weight.

Polyalkylene ether polyols suitable as the component (B) correspond to the general formula:

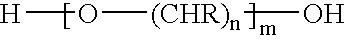

in which R=hydrogen or a lower alkyl radical which may carry various substituents, n=2 to 6 and m=3 to 50 or even higher. Examples are poly(oxytetramethylene) glycols and poly(oxyethylene) glycols.

The preferred polyalkylene ether polyols are poly(oxytetramethylene) glycols of a molecular weight in the range from 350 to 1,000.

Polyester polyols may also be used as the component (B). The polyester polyols may be prepared by polyesterification of organic polycarboxylic acids or their anhydrides with organic polyols containing primary hydroxyl groups. The polycarboxylic acids and the polyols are usually aliphatic or aromatic dicarboxylic acids and diols.

The diols used for the preparation of the polyesters include alkylene glycols such as ethylene glycol, butylene glycol, neopentyl glycol or other glycols such as cyclohexanedimethanol.

The acid component of the polyester consists primarily of low-molecular carboxylic acids or their anhydrides of 2 to 18 carbon atoms in the molecule. Suitable acids are, for example, phthalic acid, isophthalic acid, terephthalic acid, tetrahydrophthalic acid, hexahydrophthalic acid, adipic acid, azelaic acid, sebacic acid and glutaric acid. The anhydrides of these acids may also be used, insofar that they exist.

Furthermore, it is also possible to employ polyester polyols derived from lactones, as the component (B). These products are obtained by the reaction of an ε-caprolactone with a polyol. Such products are described in U.S. Pat. No. 3,169,945.

The polylactone polyols obtained by the reaction, are distinguished by the presence of a terminal hydroxyl group and recurring polyester moieties, derived from the lactone. These recurring molecular moieties may correspond to the formula

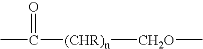

in which n is at least 4, preferably 4 to 6, and the substituent is hydrogen, an alkyl radical, a cycloalkyl radical or an alkoxy radical.

Compounds containing, for example, one or more basic nitrogen atoms may be employed as the catalyst.

Tertiary amines, such as, for example, N,N-dimethylbenzylamine, tributylamine, dimethylcyclohexylamine and dimethyl-C₁₂/C₁₄-amine (C₁₂/C₁₄ represents an aliphatic chain containing 12 to 14 carbon atoms) are preferably used.

The catalyst is usually used in an amount from 0.1 to 2% by weight, based on the intermediate produced from the components (A) and (B).

The reaction between the components (A) and (B) is carried out at temperatures between 100 and 190° C., preferably between 100 and 180° C.

In the second stage of the process according to the invention a solvent or a mixture of solvents is added to the resin solution with cooling by a secondary circuit (for example cooling via cooling coils filled with heat transfer oil or water). Solvents preferably to be added are those which cannot react with the epoxide groups still present and/or which can in any case be later added as solvents to the electrocoating paint. Particularly preferred solvents are ketones such as, for example, acetone, methyl ethyl ketone, methyl isobutyl ketone, mesityl oxide; acetates such as, for example, propyl acetate, butyl acetate; ethers such as, for example, dioxane, dibutyl ether; aromatic compounds such as, for example, toluene, xylene, ethylbenzene or mixtures of the solvents. The resin solution is caused to boil by careful application of a vacuum. Any foaming is brought under control by an appropriate lowering of the vacuum. As the temperature decreases, the pressure is gradually lowered further to achieve uniform boiling. If desired, further solvent may be added while the mixture cools, either continuously or in portions.

In stage (3), primary and/or secondary amines may be employed as the component (E), the secondary amines being particularly preferred components (E).

The amine should preferably be a water-soluble compound. Examples of such amines are monoalkylamines and dialkylamines such as methylamine, ethylamine, propylamine, butylamine, dimethylamine, diethylamine, dipropylamine, methylbutylamine and the like. Alkanolamines, such as, for example, methylethanolamine, diethanolamine and the like, are also suitable. Dialkylaminoalkylamines such as, for example, dimethylaminoethylamine, diethylaminopropylamine, dimethylaminopropylamine and the like, are likewise suitable. Low-molecular amines are used in the majority of cases, but it is also possible to employ higher-molecular monoamines.

Polyamines with primary and secondary amino groups may react with the epoxide groups in the form of their ketimines. The ketimines are prepared from the polyamines in a known manner.

The amines may also contain other groups, but these must not interfere with the reaction of the amine with the epoxide group nor must they induce gelling of the reaction mixture.

The reaction between the amines and the compounds containing epoxide groups often commences just by mixing the coreactants. Depending on the desired course of the reaction—particularly to ensure that the reaction runs to completion—it is recommended to raise the reaction temperature to 50 to 150° C. in the course of the reaction.

The crosslinking agent (F) for reduced baking temperatures added to the last stage of the process according to the invention is a polyisocyanate blocked with amino groups. These crosslinking agents are prepared by reacting a polyisocyanate with the corresponding secondary amine. The isocyanates may be aliphatic or aromatic, aromatic isocyanates being preferred for crosslinking agents for reduced baking temperatures.

Alkylene isocyanates such as, for example, trimethylene diisocyanate, tetramethylene diisocyanate, pentamethylene diisocyanate, hexamethylene diisocyanate, 1,2-propylene diisocyanate, 1,2-butylene diisocyanate, 2,3-butylene diisocyanate, 1,3-butylene diisocyanate, ethylidene diisocyanate and butylidene diisocyanate as well as cycloalkylene isocyanates such as, for example, 1,3-cyclopentane diisocyanate, 1,4-cyclohexane diisocyanate, 1,2-cyclohexane diisocyanate and isophorone diisocyanate are typical examples of aliphatic polyiso-cyanates.

Arylene isocyanates such as, for example, m-phenylene diisocyanate, p-phenylene diisocyanate, 4,4′-diphenyl diisocyanate, 1,5-naphthalene diisocyanate and 1,4-naphthalene diisocyanate as well as alkarylene isocyanates such as, for example, 4,4′-diphenylmethane diisocyanate, 2,4-toluylene diisocyanate or 2,6-toluylene diisocyanate or a mixture of 2,4- and 2,6-toluylene diisocyanates, 4,4′-toluidine diisocyanate and 1,4-xylylene diisocyanate as well as substituted aromatic systems such as, for example, dianisidine diisocyanate, 4,4′-diphenyl ether diisocyanate or chlorodiphenylene diisocyanate, 1,3,5-triisocyanatobenzene, 2,4,6-triisocyanatotoluene and 4,4′-diphenyldimethylmethane 2,2′,5,5′-tetraisocyanate as well as polymerized isocyanates are typical examples of aromatic polyisocyanates.

For crosslinking agents for reduced baking temperatures, secondary amines are preferably used for blocking the isocyanate group.

Examples of suitable monoamines are particularly secondary aliphatic, cycloaliphatic or araliphatic amines with a boiling point below 200° C., those with a boiling point between 100 and 200° C. being preferred. Examples of suitable secondary aliphatic amines are dimethylamine, diethylamine, dipropylamine, dibutylamine, dipentylamine, dihexylamine and isomers thereof, such as, for example, diisopropylamine, as well as asymmetrical compounds, such as N-ethyl-1-propanamine. Examples of suitable cycloaliphatic and araliphatic amines are dicyclohexylamine and N-methylaniline.

The reaction is carried out under conditions customary for isocyanate reactions; the reaction temperature may be from room temperature to about 150° C. If the starting materials and the reaction product are liquids at reaction temperature, it is possible to carry out the reaction without solvent; however, the reaction is generally carried out in an inert solvent such as ether, ester, ketone or hydrocarbon.

The crosslinking agent described above may be added directly at the end of stage (3) of the process according to the invention and the resultant mixture then dispersed in a water/acid mixture; however, first dispersing the reaction products from stage (3) in a water/acid mixture and only then adding the crosslinking agent is preferred.

Organic acids, such as, for example, formic acid, acetic acid or lactic acid, are employed for the preparation of the water/acid mixtures.

The procedure of the process according to the invention for the preparation of aqueous dispersions to be further processed to electrocoating paints with low baking temperatures is elucidated in greater detail by the examples below. The percentages given are percentages by weight, unless indicated otherwise.

### EXAMPLE 1

The example below describes the synthesis of an epoxide-amine resin modified with a monophenol compound, the addition of a crosslinking agent and the preparation of an aqueous dispersion of this mixture.

The crosslinking agent (I) is first prepared as follows: 2440 g of triisocyanurated hexamethylene diisocyanate are placed in a suitable reaction vessel in an atmosphere of nitrogen. 850 g of methyl isobutyl ketone (MIBK) are added and the mixture is heated to 50° C. 1560 g of di-n-butylamine are then added. The rate of the addition is controlled in such a manner that the temperature is kept to 60-70° C. At the end of the addition the temperature is raised to 75° C., and maintained at this level for one hour; 150 g of n-butanol are then added. The product has a solids content of 80% (130° C., 1 h). Both the NCO and the amine equivalent are above 20,000.

To synthesize the epoxy resin, 1884 g of an epoxy resin based on bisphenol A with an epoxide equivalent weight (EEW) of 188, 286 g of bisphenol A, 623 g of dodecylphenol and 147 g of xylene are placed in a double-walled reaction vessel which can be heated by means of heat transfer oil and is provided with a stirrer, a reflux condenser, a water separator, an inlet tube for inert gas and a vacuum connection, and the mixture is heated to 110° C. Traces of water are removed by distillation via a water separator in a continuous cycle by application of a slight vacuum. The reaction mixture is then heated to 130° C. and 11 g of N,N-dimethylbenzylamine are added, when the temperature briefly rises to 150° C. The mixture is then cooled to 130° C. and this temperature is maintained until an EEW of 1240 is reached (about 5 hours). To terminate the reaction, the reaction mixture is cooled via a secondary circuit and 225 g of xylene and 52 g of butylglycol are added in rapid succession. The solution of the resin is caused to boil under reflux by careful application of a vacuum; any foaming is brought under control by an appropriate lowering of the vacuum. When a little later 95° C. is reached, the vacuum is released and 783 g of a 70% solution of a reaction product obtained from 1 mole of diethylenetriamine and 2 mole of methyl isobutyl ketone (MIBK) in MIBK are added. After the exothermic reaction has subsided, the reaction mixture is heated to 120° C. in the course of 30 minutes and this temperature is maintained for a further 2 hours. A sample of the resin has the following characteristics:

Solids content (30 min, 180° C.): 80%

Base content: 1.47 meq/g of resin solids

910 g of this resin solution are mixed with 390 g of the crosslinking agent (I) and 19 g of glacial acetic acid are added. 850 g of water are then added in portions with stirring. The mixture is homogenized for a brief period and diluted with 960 g of water added in small portions to the final solids content.

The dispersion is freed by subsequent vacuum distillation from volatile solvents the solvent removed by distillation being replaced by equal amounts of water. The dispersion is then filtered (solids content 33.2% (1 h, 130° C.)).

### EXAMPLE 2

The example below describes the synthesis of an epoxide-amine resin modified with a monophenol compound, the addition of a crosslinking agent and the preparation of an aqueous dispersion of this mixture.

The crosslinking agent (II) is first prepared as follows: 2088 g of toluylene diisocyanate and 1746 g of MIBK are placed in a reaction vessel in an atmosphere of nitrogen and heated to 50° C. 536 g of trimethylolpropane are then added in portions. The temperature is maintained at 55-60° C. At the end of the addition the reaction mixture is maintained at this temperature for 1 hour, is then cooled to 60° C. and 1450 g of di-n-butylamine are added at such a rate that the temperature is maintained at 70-75° C. The reaction is allowed to proceed for a further 1 hour after the end of the addition. The product has a solids content of 70%. The amine equivalent and the isocyanate equivalent are both above 20,000.

To synthesize the epoxy resin, the procedure of Example 1 is followed.

910 g of the resin solution and 390 g of the cross-linking agent (II) are mixed and 21 g of glacial acetic acid are added. 850 g of water are then added in portions with stirring. The reaction mixture is homogenized for a brief period and then diluted with 960 g of water added in small portions to the final solids content.

The dispersions are freed by subsequent vacuum distillation from volatile solvents, the solvent removed by distillation being replaced by equal amounts of water. The dispersion is then filtered (solids content 33.4% (1 h, 130° C.)).

### COMPARISON EXAMPLE

The procedure of Example 1 is followed until the EEW of 1240 is reached. 1785 g of the crosslinking agent (I) and 783 g of a 70% solution of a reaction product obtained from diethylenetriamine and methyl isobutyl ketone in methyl isobutyl ketone are added. The reaction mixture is adjusted to a temperature of 112° C. and this temperature is maintained for 1 hour.

19 g of glacial acetic acid are added to 1200 g of this resin solution and 850 g of water are added in portions with stirring. The mixture is homogenized for a brief period and diluted with 960 g of water added in small portions to the final solids content.

The dispersion is freed in subsequent vacuum distillation from volatile solvents, the solvent removed by distillation being replaced by equal amounts of water. The dispersion is then filtered (solids content 35.1% (1 h, 130° C.)).

Electrocoating baths are prepared from the binder dispersions described in Examples 1 and 2 and in the comparison example 1 with a gray pigment paste.

To prepare a gray pigment paste, 800 parts of butylglycol are added to 953 parts of a commercially available epoxy resin based on bisphenol A (epoxide equivalent weight of 890) and the mixture is heated to 80° C. 221 parts of a reaction product obtained from 101 parts of diethanolamine and 120 parts of 80% aqueous lactic acid are then added to the resin solution. The reaction is carried out at 80° C. until the acid value has dropped below 1.

1800 parts of this product are mixed with 2447 parts of deionized water and this mixture is treated with 2460 parts of TiO₂, 590 parts of an extender based on aluminum silicate, 135 parts of lead silicate and 37 parts of carbon black. This mixture is ground in a millbase to a Hegman fineness of 5 to 7. 1255 parts of deionized water are then added in order to reach the desired paste consistency.

The electrocoating baths are obtained by mixing:

2280 parts of deionized water 25 parts of 10% acetic acid

1920 parts of aqueous crosslinking agent/epoxide-amine adduct dispersion

775 parts of pigment paste.

The deposition of the paint films is carried out at a bath temperature of 26° C. for 120 seconds. Zinc phosphated panels are connected as cathode for this purpose and coated. The curing of the deposited films is carried out for 20 minutes in a circulating air oven at temperatures indicated in the table together with deposition data.

The deposition results are summarized in the tables below:

| | | |
|---|---|---|
| | | Comparison |
| Example 1 | Example 2 | example |

Deposition data:

| | | | |
|---|---|---|---|
| Deposition data | | | |
| Deposition voltage (V) | 300 | 320 | 330 |
| Film thickness (μm) | 23 | 21 | 19 |
| Baking temperature (° C.) | 145 | 130 | 145 |
| FORD throwing | 20.5 | 22 | 20 |
| power (cm) | | | |

Mechanical properties:

| | | | |
|---|---|---|---|
| Test method | | | |
| Erichsen indentation | 8 | 4 | 6 |
| (mm) | | | |
| Crosshatch | 0 | 0 | 1 |
| (0 best, 5 worst) | | | |
| Bending test | pass | pass | pass |
| Impact test | 0.92 | 0.69 | 0.69 |
| (m kg) | | | |
| Flow-out | 0.5 | 1.5 | 4.5 |
| (0 best, 5 worst) | | | |

1. A process for the preparation of aqueous dispersions
which are used for the preparation of aqueous electrocoating paints capable of being cathodically deposited and heat-curable at temperatures below 160° C. and baking times of ≦30 minutes by admixed crosslinking agents
which contain modified epoxide-amine adducts as binders capable of being cathodically deposited
which contain polyisocyanates blocked by amino groups as crosslinking agents,
wherein
(1) (A) polyepoxides and
(B) compounds which contain one or more, preferably 2, hydroxyl groups attached to aromatic and/or (cyclo)aliphatic molecular fragments per molecule,
are reacted in the presence of catalysts at elevated temperatures, preferably at from 100 to 180° C., to furnish
(C) epoxide-containing intermediates;
(2) (D) a solvent or a mixture of solvents is added with external cooling and the resultant resin solution is caused to boil under reflux, if necessary by application of a vacuum, until the temperature of the solution drops to 95° C. to 20° C.;
(3) (E) amines are added onto the epoxide groups which are still present in a free state in the epoxide resin and either
(4a) these reaction products are dispersed in a water-acid mixture and the crosslinking agent (F) is admixed, or
(4b) the crosslinking agent (F) is mixed with these reaction products and this mixture is dispersed in a water-acid mixture.

2. The process as claimed in claim 1, wherein the polyisocyanates are aliphatic polyisocyanates.

3. The process as claimed in claim 1, wherein the polyisocyanates are aromatic polyisocyanates.

4. The process as claimed in one of the claims 1 to 3, wherein substances are used as solvents in stage (2) which cannot react with the epoxide groups still present in the resin.

5. The process as claimed in one of the claims 1 to 4, wherein the resin solution in stage (2) is cooled to temperatures ≧50° C.

6. The process as claimed in one of the claims 1 to 5, wherein the solvent is removed in vacuo at temperatures below 65° C. after preparation of the aqueous dispersion.
